(19) United States
(12) Patent Application Publication
(10) Pub. No.: US 2011/0289911 A1
(43) Pub. Date: Dec. 1, 2011

(54) HYDRAULIC SYSTEM AND METHOD OF ACTIVELY DAMPING OSCILLATIONS DURING OPERATION THEREOF

(76) Inventor: Mark Phillip Vonderwell, Franklin, WI (US)

(21) Appl. No.: 12/791,566

(22) Filed: Jun. 1, 2010

(51) Int. Cl. F15B 11/04; F15B 21/12

(52) U.S. Cl. 60/431; 60/327

(57) ABSTRACT

A hydraulic system and a method of actively damping oscillations during actuation of a hydraulic cylinder in a hydraulic system is disclosed. The hydraulic cylinder is actuated by energizing a motor that rotatably drives a pump. The pump supplies a fluid to the hydraulic cylinder to actuate the cylinder. A pressure of the fluid is sensed during actuation of the hydraulic cylinder. A rotational speed of the motor is varied in response to the sensed pressure of the fluid. This varying of the rotational speed of the motor actively damps pressure oscillations during actuation of the hydraulic cylinder.

### CROSS-REFERENCE TO RELATED APPLICATION

Not applicable.

### STATEMENT OF FEDERALLY SPONSORED RESEARCH OR DEVELOPMENT

Not applicable.

### BACKGROUND OF THE INVENTION

This invention relates to a hydraulic system. In particular, this invention relates to a hydraulic system that actively damps oscillations during the actuation of a hydraulic cylinder.

Large industrial equipment, such as earth-moving machines, often utilize hydraulic systems to move heavy components and/or loads. Typically, a pump is used to supply fluid to a hydraulic cylinder having a movable piston. By supplying fluid to the hydraulic cylinder, the piston is extended and/or retracted to actuate a portion of the machine.

Unfortunately, however, the hydraulic fluid may effectively behave as a spring if the fluid is sufficiently compressible and the load being moved is sufficiently heavy. The larger a load is, the greater its inertia. Particularly at the start or the end of a piston stroke, a large mass will want to either stay where it is positioned or to continue to move at the present speed. When a large mass is accelerated or decelerated during actuation, these inertia tendencies cause oscillations in the pressure of the hydraulic fluid and the rate at which the mass is moved. Accordingly, the components of the machine can “bounce” when actuated.

Some have attempted to avoid such oscillations in pressure by building damping mechanisms into the hydraulic system. According to one damping mechanism, the flow of fluid from the pump is split between the hydraulic cylinder and a tank. When the line is split between the hydraulic cylinder and the tank, the division of the flow between the two paths varies with oscillating cylinder pressure, creating a form of built-in damping. For example, if the fluid is being supplied to the cylinder and the pressure in the cylinder increases due the inertia of the load, the fractional flow from the pump to the cylinder decreases, while the fractional flow to the separate tank increases. Similarly, if the pressure in the cylinder decreases, the fractional flow to the cylinder increases while the fractional flow to the separate tank decreases. One benefit of this type of damping mechanism is that there is zero lag as the flow splitting happens instantaneously.

Although this type of flow-splitting damps oscillations quickly, there are many disadvantages to such a system. For one, the tank requires additional space and adds to the cost of the machine. As this tank receives a fraction of the pumped fluid (since the flow is split), more than just the minimum amount of fluid necessary to actuate the cylinder alone must be pumped in order to achieve the same amount of actuation. Moreover, dampening oscillations in this manner generally requires extracting energy from the oscillations. This results in the loss of energy through generated heat—making the machine less efficient.

In an alternative method of avoiding pressure oscillations, the hydraulic cylinder might be actuated in such a way as to avoid exciting the natural frequency of oscillation. However, this only avoids exciting such oscillations rather than eliminating them via damping. Further, this places limitations on the rate and/or manner in which the system can be operated.

Hence, there is a need for improved damping of hydraulic systems in which oscillations in pressure of the hydraulic fluid result in undesired bouncing of actuated components.

### SUMMARY OF THE INVENTION

A method and hydraulic system are disclosed which provide for the active damping of oscillations in the pressure of a hydraulic fluid. This active damping more efficiently eliminates bouncing of components by adjusting the source of the fluid pressure (typically a positive displacement pump) in response to a detected pressure of the hydraulic fluid.

A method of actively damping oscillations during actuation of a hydraulic cylinder is disclosed. The hydraulic cylinder is actuated by energizing a motor that rotatably drives a pump which, in turn, supplies a fluid to the hydraulic cylinder. A pressure of the fluid is sensed during actuation of the hydraulic cylinder. In response to the sensed pressure of the fluid, a rotational speed of the motor is varied. The adjustment of the rotational speed of the motor actively damps pressure oscillations during actuation of the hydraulic cylinder.

The pressure may be sensed using a pressure sensor. If the pressure of the fluid is sensed to be above a target pressure, the rotational speed of the motor may be reduced. If the pressure of the fluid is sensed to be below a target pressure, the rotational speed of the motor may be increased.

A controller may control operation of the motor and may receive a pressure signal from a pressure sensor indicating the pressure of the fluid. In some forms, a user control may also be in communication with the controller. The user control may provide a rate signal to the controller indicating a target rate of actuation of the hydraulic cylinder. The controller may evaluate the pressure signal and the rate signal to determine the rotational speed at which to energize the motor. During the step of varying the rotational speed of the motor, the controller may insert a time shift to account for a response time of the motor and/or the pump.

A hydraulic system is also disclosed. The hydraulic system includes a hydraulic cylinder, a pump supplying a fluid to the hydraulic cylinder to actuate the hydraulic cylinder, a variable speed motor driving the pump, a pressure sensor sensing a pressure of the fluid, and a controller. The controller is in communication with the variable speed motor and the pressure sensor. The controller is configured to (1) receive a pressure signal from the pressure sensor and (2) instruct the variable speed motor to operate at one of a plurality of speeds. During actuation of the hydraulic cylinder, the controller evaluates the pressure signal and actively damps oscillations in the pressure of the fluid by varying the speed of the variable speed motor based, at least in part, on the pressure signal.

In some forms, the pump may be a positive displacement pump.

The hydraulic system may include a user control to set a target rate of actuation. The user control may be in communication with the controller to provide a rate signal to the controller. The controller may be configured to evaluate both the rate signal of the user control and the pressure signal of the pressure sensor in determining the speed at which to instruct the variable speed motor to operate.

The pressure sensor may be linked to the hydraulic cylinder or may be linked to a line in fluid communication with the hydraulic cylinder.

A method of actively damping oscillations during actuation of a hydraulic cylinder by a pressure source is also disclosed. According to the method, a pressure of a fluid actuating the hydraulic cylinder is sensed during actuation of the hydraulic cylinder. The pressure source is adjusted in response to the pressure of the fluid to damp oscillations in the pressure of the fluid.

Accordingly, the disclosed methods and hydraulic system provide a more efficient way of damping oscillations. In contrast to old solutions, such as flow-splitting, the disclosed method and system require less space for equipment such as a separate tanks. There is less energy lost due to heat dissipation as the system is configured to more precisely provide the appropriate amount of energy required to actuate the cylinder rather than to absorb any excess energy. Additionally, in contrast to solutions which avoid exciting natural oscillation frequencies, the disclosed method and system do not limit the operational range of the hydraulic system.

These and still other advantages of the invention will be apparent from the detailed description and drawings. What follows is merely a description of some preferred embodiments of the present invention. To assess the full scope of the invention the claims should be looked to as these preferred embodiments are not intended to be the only embodiments within the scope of the claims.

### BRIEF DESCRIPTION OF THE DRAWINGS

FIG. 1 is a schematic of a hydraulic system in which a pressure sensor is directly attached to the hydraulic cylinder;

FIG. 2 is a schematic similar to FIG. 1, except that the pressure sensor is attached to a line in fluid communication with the hydraulic cylinder; and

FIG. 3 is a flowchart illustrating the method of actively damping oscillations in the hydraulic fluid; and

FIG. 4 is a chart illustrating one possible relationship between a user input, a sensed pressure, and a speed of the motor for a particular hydraulic system.

### DETAILED DESCRIPTION OF THE PREFERRED EMBODIMENTS

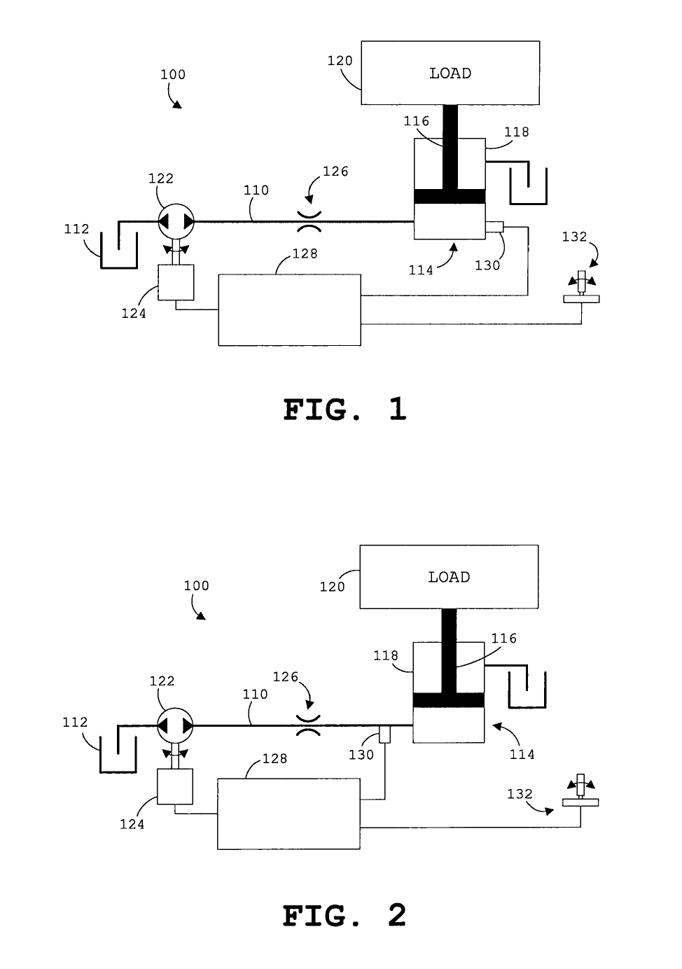

Referring first to FIGS. 1 and 2, a combined electronic and hydraulic schematic is illustrative of a hydraulic system 100 for a machine such as, for example, an earth moving or mining machine. The darker lines indicate hydraulic lines or components while the lighter lines indicate electrical connections.

With respect to the hydraulic components of the schematics, a hydraulic line 110 places a reservoir 112 on the left side of the schematics in fluid communication with a hydraulic cylinder 114 on the right side of the schematics. The hydraulic cylinder 114 includes a piston 116 actuatable within a cylinder 118 by a hydraulic fluid supplied from the reservoir 112 via the hydraulic line 110. The piston 116 is linked to a load 120, the load 120 comprising machine components including the piston 116 itself and/or separate items lifted by the machine components.

A pressure source in the form of a hydraulic pump 122 is located along the hydraulic line 110. When operated, the hydraulic pump 122 transports hydraulic fluid, such as oil, from the hydraulic reservoir 112 into the hydraulic cylinder 114 to effectuate the actuation of the piston 116. In the particular form shown, the hydraulic pump 122 is a bi-directional pump and is energized by an electric motor 124 operable at various rotational speeds and directions to alter the rate and direction at which the hydraulic pump 122 transports the hydraulic fluid. In other forms, two separate and alternately directed one-way positive displacement pumps with check valves in parallel may be used to achieve the same hydraulic effect as a single bi-directional pump.

The hydraulic pump 122 and the electric motor 124 may be run in either (1) a forward direction in which the electric motor 124 drives the hydraulic pump 122 to move fluid from the reservoir 112 into the hydraulic cylinder 114 or (2) in a reverse direction in which the hydraulic fluid flows from the hydraulic cylinder 114 back into the reservoir 112 and, as the hydraulic pump 122 spins backwards, the electric motor 124 acts as a generator to produce electrical energy that may be utilized elsewhere in the machine. As will be described in more detail below, active damping of the hydraulic cylinder 114 may be obtained in either flow direction by altering the speed of the hydraulic pump 122 in the forward or reverse direction as appropriate.

It should be appreciated that although the hydraulic cylinder 114 is illustrated such that supplying hydraulic fluid to the hydraulic cylinder 114 causes the piston 116 to extend, that the hydraulic cylinder 114 may be differently configured. For example, the hydraulic cylinder 114 may be configured such that the introduction of hydraulic fluid causes the piston 116 to retract, by altering the side of the piston plunger to which the fluid is supplied. This alternative configuration may be desirable, for example, if the hydraulic cylinder 114 is positioned such that retraction of the piston 116 will cause the load 120 to be lifted against the force of gravity (not shown).

The hydraulic line 110 also includes a metering orifice 126 used to regulate the flow of hydraulic fluid through the hydraulic line 110.

It will be appreciated that other hydraulic lines, valves, and/or hydraulic elements, although not shown, may be part of the hydraulic system 100. For example, there may be a valve to a separate line which opens when fluid runs from the hydraulic cylinder 114 back in the reservoir 112. Such a valve system might be useful if fluid cannot or should not run backwards through the pressure source.

Turning now to the electrical components of the illustrated hydraulic system 100, a controller 128, such as a computer, programmable controller, CPU, and the like, is electrically connected to many of the other electrical components and/or sensors. The controller 128 is preferably, further connected to the aforementioned electric motor 124, a pressure sensor 130, and a user control 132 such as a joystick.

The pressure sensor 130 measures the pressure of the hydraulic fluid and is linked, connected, and/or attached either to the hydraulic cylinder 114 as shown in FIG. 1 or to a portion of the hydraulic line 110 in fluid communication with the hydraulic cylinder 114 as shown in FIG. 2. The pressure sensor 130 is configured to sense a pressure of the fluid (at least during actuation of the hydraulic cylinder 114) and to provide this sensed reading as a pressure signal to the controller 128. The pressure sensor 130 is an electro-mechanical device or any suitable type of sensor device for sensing a pressure of a fluid and providing a signal associated with the sensed pressure.

The user control 132 is also connected to the controller 128 and provides a user with an interface for the controller 128 for controlling the actuation of the hydraulic cylinder 114. The user control 132 could be any electrical control, mechanical control, electro-mechanical control, virtual control (i.e., touch screen control), or other type of control. When manipulated by a user, the user control 132 provides a rate signal to the controller 128 which indicates the target rate of actuation at which it is desired that the piston 116 will move within the cylinder 118. In some forms, the user control 132 also provides information, either in the rate signal or in a separate signal, indicating the direction (i.e., extension or retraction) of actuation of the piston 116.

The user control 132 may be configured to provide a number of different rate signals indicating various different speeds for actuation or may be configured to provide a single type of rate signal to indicate whether or not the piston 116 should be actuated without further detail as to the rate at which it should be actuated. Of course, the former configuration provides the user with more fine control over the actuation of the components.

As will be described in further detail below with respect to the method, the controller 128 provides operations instructions to the electric motor 124. These operation instructions include, among other things, whether the electric motor 124 should be operating (and, thus, energizing the hydraulic pump 122) and the rotational speed at which the electric motor 124 should operate.

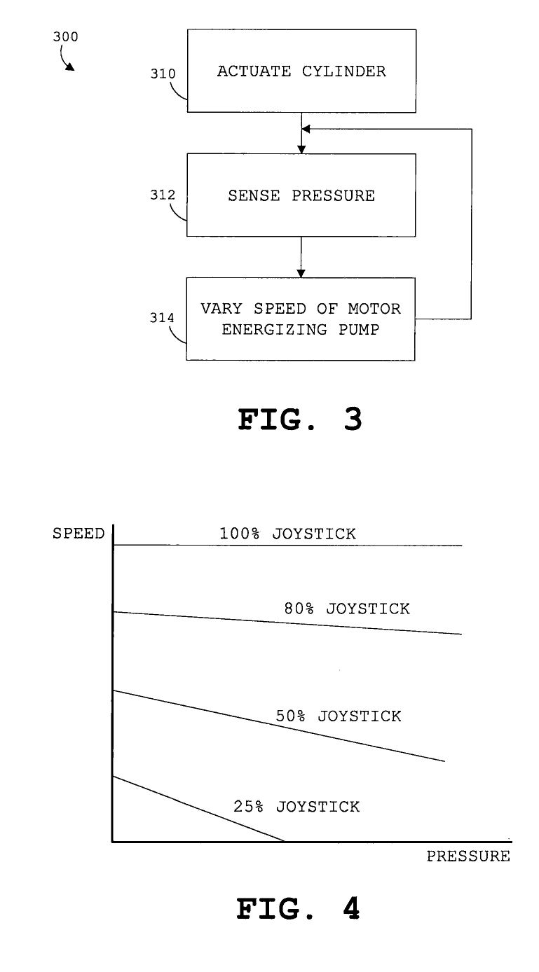

These example schematics having been described, a method 300 of actively damping oscillations in pressure during actuation of the hydraulic cylinder 114 is disclosed in FIG. 3.

First, the hydraulic cylinder 114 is actuated according to step 310. This actuation may be initiated by either a user operating the user control 132 to provide a rate signal to the controller 128 or via some other instruction to the controller 128. Upon receiving this signal, the controller 128 processes the signal and instructs the electric motor 124 to operate in such a way as to rotatably energize the hydraulic pump 122. The hydraulic pump 122 pumps fluid from the reservoir 112 into the hydraulic cylinder 114. By supplying fluid to the hydraulic cylinder 114, the piston 116 is actuated within the cylinder 118 and the load 120 is moved by the hydraulic cylinder 114.

When the mass of the load 120 is a large mass, the load 120 has high inertial tendencies. Under normal conditions, once the hydraulic cylinder 114 is actuated as in step 310, the load 120 initially wants to stay at rest. Likewise, upon ending the actuation (e.g., at the end of a stroke), the load 120 wants to continue moving at the rate it was previously travelling. In either case, this inertial tendency causes oscillations in the rate at which the load is moved as well as in the pressure of the hydraulic fluid, particularly at the start and stop of actuation when the load is accelerated or decelerated.

For example, if the piston 116 is to be extended from an initially retracted position at the start of actuation by pumping hydraulic fluid into the hydraulic cylinder 114, then the load 120 initially wants to stay at its present position and at rest. This inertial tendency typically results in an initial increase in pressure of the hydraulic fluid as the pressure continues to increase with limited movement of the load 120. Eventually, this pressure become sufficiently high so as to actuate the piston 116 and the load 120. However, again given the inertial tendencies of the load 120, the load 120 now will likely overshoot the target position at a given time, resulting in a relative drop in pressure at the peak of the over compensation. The load 120 will bounce back and forth in this manner as it is actuated with the peaks and valleys of the over- or under-pressure decreasing or tapering off as the actuation approaches a steady state velocity.

To combat this tendency of the load 120 to bounce, during the actuation of the cylinder, the oscillations in the pressure and rate at which the load 120 is moved are actively damped. The pressure of the hydraulic fluid is sensed by the pressure sensor 130 according to step 312. Based on the sensed pressure in step 312, the speed of the electric motor 124 is varied according to step 314. The speed of the electric motor 124 is varied to maintain a target hydraulic fluid pressure. Target hydraulic fluid pressure is determined by operator input.

The sensing of the pressure of the fluid and the varying of the speed of the electric motor 124 may be continuously performed or may occur only periodically during actuation. However, the sensing and varying should be sufficiently frequent to detect these oscillations in pressure and then alter the motor speed so as to damp them.

Some examples are now provided as to how the speed of the electric motor 124 is varied according to the sensed pressure and, in some cases, the rate signal provided by the user control 132.

The controller 128 evaluates the pressure signal supplied by the pressure sensor 130 and/or the rate signal supplied by the user control 132 to determine a target pressure and, further, to access whether the sensed pressure is above or below the target pressure rate.

Referring to FIG. 4, in one form, the controller 128 receives any inputs, such as the pressure signal and the rate signal, and uses these signals to determine the speed at which to operate the electric motor 124. As shown, the various lines (e.g., 100% joystick, 80% joystick, etc.) refer to rate signals associated with a particular magnitude of operation of a user control 132, such as a joystick. For example, 80% joystick refers to a condition in which a user has manipulated the control to 80% of capacity. The 80% joystick condition also corresponds to a particular target rate of actuation of the hydraulic cylinder 114. Along the x-axis of FIG. 4 are pressure values, which correspond to a sensed pressure value provided by the pressure signal. By taking the pressure signal and the rate signal into consideration, a corresponding speed (found along the y-axis) is established at which the electric motor 124 should be run to damp pressure oscillations in the hydraulic fluid.

Observing the trends in the particular graph provided in FIG. 4, the lines tend to trend downwards. Thus, for a given target pressure, if the sensed pressure were to exceed the target pressure value, the speed of the motor is reduced (reducing the pressure in the line and hydraulic cylinder). If the sensed pressure were to be less than the target pressure value, then the speed of the motor is increased (increasing the pressure in the line and cylinder).

It should be appreciated that the shown relationships in FIG. 4 are representative. The relationships need not be linear and various types of relationships may be appropriate for different actuation conditions.

It should further be appreciated that there may be some time response associated with sensing the pressure and then varying the pressure source. Accordingly (as the occurrence of such oscillations are periodic), the controller 128 may be configured to observe the frequency and magnitude of the oscillations and insert a time shift to better anticipate and damp oscillations as they occur.

Moreover, active damping may occur in either direction of actuation (i.e., either forward or reverse flow directions) using the bi-directional pump 122 and electric motor 124. For example, in the hydraulic system 100 of FIGS. 1 and 2, during extension of the hydraulic cylinder 114 the electric motor 124 is continuously running the hydraulic pump 122 forward to provide the necessary force to extend the piston 116. In this direction, the speed of the motor 124 may be varied to actively damp the oscillation (albeit over a range of speeds in a forward direction). In the reverse flow direction in which the hydraulic cylinder 114 retracts, active damping of the hydraulic cylinder 114 may be achieved, for example, by having the motor 124 speed increase (i.e., move faster in the reverse direction) when the detected pressure in the hydraulic cylinder 114 increases.

By making the adjustments indicated above any oscillations in pressure are actively damped as soon as they occur. Further, the damping of oscillations will also result in a more consistent rate of actuation, as pressure oscillations impede obtaining a consistent rate of actuation.

Advantageously, the sensing and damping in this manner is more efficient than known techniques such as flow splitting. The active response to deviations in pressure require little more energy expenditure than that required to actuate the hydraulic cylinder. As there is no separate tank, significant energy is not spent pumping more fluid than necessary.

It should be appreciated that various other modifications and variations to the preferred embodiments can be made within the spirit and scope of the invention. Therefore, the invention should not be limited to the described embodiments. To ascertain the full scope of the invention, the following claims should be referenced.

What is claimed is:

1. A method of actively damping oscillations during actuation of a hydraulic cylinder, the method comprising:
actuating the hydraulic cylinder by energizing a motor rotatably driving a pump supplying a fluid to the hydraulic cylinder;
sensing a pressure of the fluid during actuation of the hydraulic cylinder; and
varying a rotational speed of the motor in response to the pressure of the fluid to actively damp pressure oscillations during actuation of the hydraulic cylinder.

2. The method of claim 1, wherein the step of sensing the pressure is performed using a pressure sensor.

3. The method of claim 1, wherein during actuation, if the pressure of the fluid is sensed to be above a target pressure, the rotational speed of the motor is reduced.

4. The method of claim 1, wherein during actuation, if the pressure of the fluid is sensed to be below a target pressure, the rotational speed of the motor is increased.

5. The method of claim 1, further comprising a controller that controls operation of the motor and that further receives a pressure signal from a pressure sensor indicating the pressure of the fluid.

6. The method of claim 5, further comprising a user control in communication with the controller, the user control providing a rate signal to the controller indicating a target rate of actuation of the hydraulic cylinder.

7. The method of claim 6, wherein the controller evaluates the pressure signal and the rate signals to determine the rotational speed at which to energize the motor.

8. The method of claim 5, wherein, during the step of varying the rotational speed of the motor, the controller inserts a time shift to account for a response time of at least one of the motor and the pump.

9. A hydraulic system comprising:
a hydraulic cylinder;
a pump supplying a fluid to the hydraulic cylinder to actuate the hydraulic cylinder;
a variable speed motor driving the pump;
a pressure sensor sensing a pressure of the fluid; and
a controller in communication with the variable speed motor and the pressure sensor, the controller being configured to receive a pressure signal from the pressure sensor and being further configured to instruct the variable speed motor to operate at one of a plurality of speeds;
wherein, during actuation of the hydraulic cylinder, the controller evaluates the pressure signal and actively damp oscillations of the pressure of the fluid by varying the speed of the variable speed motor based at least in part on the pressure signal.

10. The hydraulic system of claim 9, wherein the pump is a positive displacement pump.

11. The hydraulic system of claim 9, further comprising a user control to set a target rate of actuation.

12. The hydraulic system of claim 11, wherein the user control is in communication with the controller to provide a rate signal to the controller.

13. The hydraulic system of claim 12, wherein the controller is configured to evaluate both the rate signal of the user control and the pressure signal of the pressure sensor in determining the speed at which to instruct the variable speed motor to operate.

14. The hydraulic system of claim 9, wherein the pressure sensor is linked to the hydraulic cylinder.

15. The hydraulic system of claim 9, wherein the pressure sensor is linked to a line in fluid communication with the hydraulic cylinder.

16. A method of actively damping oscillations during actuation of a hydraulic cylinder by a pressure source comprising:
sensing a pressure of a fluid actuating the hydraulic cylinder during actuation; and
adjusting the pressure source in response to the pressure of the fluid to damp oscillations in the pressure of the fluid.
